(19) United States
(12) Patent Application Publication
(10) Pub. No.: US 2010/0224692 A1
(43) Pub. Date: Sep. 9, 2010

(54) NOVELTY MONSTER REPELLANT

(76) Inventor: Ziyad Qumsieh, Bolingbrook, IL (US)

Correspondence Address: LAW OFFICE OF JERRY D. HAYNES , P.A, P.O. Box 350392, Fort Lauderdale, FL, 33335, US

(21) Appl. No.: 12/399,554

(22) Filed: Mar. 6, 2009

(51) Int. Cl. B05B 17/00

(52) U.S. Cl. 239/1; 239/289

(57) ABSTRACT

The present invention relates to a repellant spray device and a method for using the same. The repellent spray device may be used to assist children in sleeping. The repellent spray device includes: an aerosol spray can; a spray nozzle engaged upon the aerosol spray can; a scented spray within the spray can, wherein the spray is released through the spray nozzle upon depression thereof; and a graphic image depicted on the spray can. The graphic image may be a fictional character where the fictional character includes a ghost, monster, hideous creature, animated character or alien character. A bold stripe crosses diagonally across the graphic image. The present invention also includes a particular scent associated with each fictional character.

### BACKGROUND OF THE INVENTION

1. Field of Invention

The present invention relates to a novelty item to assist children overcoming imaginary fears.

2. Description of Related Art

Many times children develop fears of imaginary entities that do not exist. Occasionally these fears may disrupt a child's sleep or impede their ability to go to sleep. Sometimes if children sleep alone these fears are exaggerated and therefore difficult to control. Children may eventually grow out of these fears however many times it may take years before they achieve the level of comfort necessary to overcome these fears. The fears may also impede the childhood development and a child may develop over-dependency issues due to these fears.

One particular fear relates to the fear of the dark. Typically such a fear has been addressed with the use of a nightlight or perhaps leaving the light on itself within the child's bedroom. Other fears children may have include fears of sounds during the night and perhaps even associating the sounds with ghosts. Sounds during the night may be exaggerated due to the overall quiet environment of a home and children sometime associate these sounds with imaginary ghosts. Parents or guardians attempt to address these fears by reading children bedtime stories or by giving the child a sleep companion such as a stuffed animal. Also when addressing the fear of ghosts, parents may need to pretend they are checking throughout the child's bedroom and searching closets to confirm the lack of ghosts or other imaginary creatures. Many times these fears are developed due to a child's exposure to certain images on television or in movies.

Consequently, it would be advantageous to have some type of novelty device or method to address the fears that might be encountered by a child at night. Such a device could assist in alleviating the fears of the child and allowing the child to have a good night sleep. Further parents will also be able to achieve a goodnight's sleep because their children will be asleep instead of awake due to their fear of creatures that simply do not exist.

### SUMMARY OF THE INVENTION

The present invention relates to a repellant spray device for use to assist children in sleeping comprising: an aerosol spray can; a spray nozzle engaged upon the aerosol spray can; a scented spray within the spray can, wherein the spray is released through the spray nozzle upon depression thereof; and a graphic image depicted on the spray can. The graphic image may be a fictional character where the fictional character includes a ghost, monster, hideous creature, animated character or alien character. A bold stripe crosses diagonally across the graphic image. The present invention also includes a particular scent associated with each fictional character.

The present invention further contemplates a method of repelling fictional characters in order to quell a child's fears thereof comprising the steps of: introducing the child to a repellent spray device, wherein said device includes a spray can with a nozzle and an image of a fictional character on said spray can, where a bold stripe diagonally crosses said image; convincing the child of the effectiveness of said repellent device to repel the fictional character portrayed in the image; releasing a scent mist into the atmosphere near the child by depressing the nozzle of said spray can; and repeating the steps of convincing and releasing the spray, until the child's fear of the fictional character has been quelled.

### BRIEF DESCRIPTION OF DRAWINGS

FIG. 1 depicts an exemplary embodiment of a monster repellant according to the present invention.

FIGS. 2A through 2D depict specific embodiments of the monster repellant according to the present invention.

### DETAILED DESCRIPTION

The present invention provides a novel unique means to assist parents and guardians to address a child's fears that may be related to imaginary monsters or creatures in the night. The present invention provides a monster repellant that could be used to address a child's fear and ensure that the child can achieve a comfortable environment in order to go to sleep.

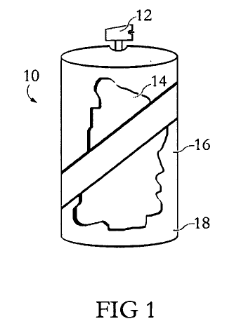

FIG. 1 shows a general embodiment of a monster repellent according to the present invention. The present invention includes an aerosol can 10 with a spray nozzle 12. The aerosol can 10 contains a scented spray that is released through the spray nozzle 12 upon depression thereof. The scented spray may be used to spray a child's bedroom in order to lead the child to believe that the spray repels and extinguishes any ghosts that may exist in the room.

The aerosol can 10 includes a graphic design 14 with a background color 16. Also on the can is a written description 18 of the designated purpose of the aerosol spray. The graphic design lies behind a bold stripe which strikes through the image on the graphic design 14. This stripe that is over the graphic design 14 is similar to one that is used in traffic signs that alert a person not to make a left turn or right turn and is used in this particular application to designate that this spray repels the associated image that's behind the stripe.

The monster repellant within the aerosol can 10 has the ability to give children the perception that their fears are without cause and that the repellant is repelling or extinguishing any ghosts that may be in the room. In films and television, fictional monsters and ghosts may be depicted as being vulnerable to a various mists and sprays which in turn disintegrated the imaginary ghost or monster. The monster repellant according to the present invention therefore provides a means for parents to quell the fears of their children.

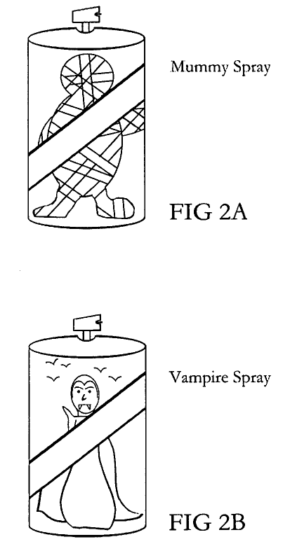

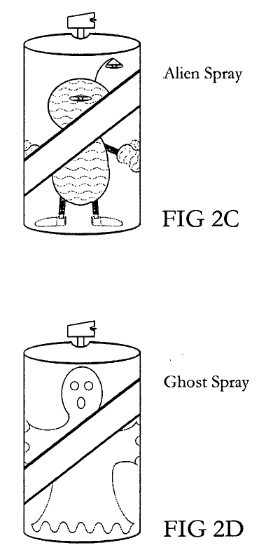

FIG. 2A through 2D shows exemplary monster repellant cans according to the present invention. FIG. 2A shows a graphic image of a mummy placed behind the slash. Consequently, this particular repellant provides imaginary protection from mummies and a parent or guardian can use this variation to for a child that is afraid of mummies. Ideally the parent or guardian ensures that a mummy cannot withstand the repellant being sprayed out of the spray can. Similar exemplary embodiments are shown in FIGS. 2B, 2C and 2D. FIG. 2B shows a vampire repellant where there's a graphic depiction of a vampire on the aerosol can, FIG. 2C shows a graphic design of an alien, according to folklore, on the spray can 10 and FIG. 2D depicts a ghost graphic design, again as depicted in conventional folklore, behind the slash sign on the Aerosol can 10.

The aerosol cans according to the present invention may be sold as a complete kit which provides a variety of repellants for the fears that children may have before going to bed. Although four exemplary graphic designs are depicted in this application, the number of designs is essentially endless. Monster repellant aerosol cans could be developed for specific monsters such as Frankenstein, The Thing or Zombies. Also these monster repellant cans may be associated with the latest characters or monsters that are depicted in motion pictures or television shows. Such as the Harry Potter monsters that are depicted in various Harry Potter movies, huge dinosaurs that are depicted in monster movies such as Godzilla, gremlins which was a popular movie franchise at one time, the six-legged monster of folklore, large insects, or even renowned villains such as Freddy Kruger, Predator or Alien. Consequently, the list of exotic creatures and applications for this monster repellant spray is virtually endless. The methodology associated with the present invention involves first convincing a child that the repellant works. Since it is used with the children that may be affected by these fears, this initial step should not produce a great challenge to the parent or guardian. The parents can show the can to the child and then ensure to spray within the room and areas that the child may feel the monsters may lurk. The monster repellant helps to sooth the child's fears prior to going to sleep. Each spray repellant may have a different scent and the scent may induce a calming effect similar to the aromatherapy that is currently used in adult spa treatments. So consequently, once the child's bedroom is sprayed with this monster repellent according to present invention, the fears should be reduced or diminished sufficiently so that the child may acquire a good night's sleep. The instant invention has been shown and described in what is considered to be the most practical and preferred embodiments. It is recognized, however, that departures may be made there from within the scope of the invention and that obvious modifications will occur to a person skilled in the art.

What is claimed is:

1. A repellant spray device for use to assist children in sleeping comprising:
a. an aerosol spray can;
b. a spray nozzle engaged upon the aerosol spray can;
c. a scented spray within the spray can, wherein the spray is released through the spray nozzle upon depression thereof; and
d. a graphic image depicted on the spray can.

2. The repellent spray device according to claim 1 wherein the graphic image is a fictional character where the fictional character includes at least one of a ghost, monster, hideous creature, animated character and alien.

3. The repellent spray device according to claim 1, wherein a bold stripe crosses diagonally across the graphic image.

4. The repellent spray device according to claim 2, wherein a particular scent is associated with each fictional character.

5. A method of repelling fictional characters in order to quell a child's fears thereof comprising the steps of:
a. introducing the child to a repellent spray device, wherein said device includes a spray can with a nozzle and an image of a fictional character on said spray can, where a bold stripe diagonally crosses said image;
b. convincing the child of the effectiveness of said repellent device to repel the fictional character portrayed in the image;
c. releasing a scent mist into the atmosphere near the child by depressing the nozzle of said spray can; and
d. repeating steps b and c, until the child's fear of the fictional character has been quelled.
